(19) United States
(12) Patent Application Publication
(10) Pub. No.: US 2005/0278291 A1
(43) Pub. Date: Dec. 15, 2005

(54) System and Method for Data Visualization

(76) Inventors: Dana John Barrette, Pewee Valley, KY (US); Mark Evan Davidson, Crestwood, KY (US)

Correspondence Address: Dana J. Barrette, 111 Sedley Court, Pewee Valley, KY, 40056, US

(21) Appl. No.: 10/904,549

(22) Filed: Aug. 1, 2005

Related U.S. Application Data
(60) Provisional application No. 60/523,606, filed on Nov. 20, 2003.

(51) Int. Cl. G06F 7/00

(52) U.S. Cl. 707/1

(57) ABSTRACT

The present invention relates to a system and method of collecting, transforming, displaying, and visualizing business performance measures to facilitate analysis and decision making. The invention is suitable for use in conjunction with a user's management information systems and permits multiple users within a single organization to access the business performance measures in a plurality of formats.

### SUMMARY OF THE INVENTION

The present invention provides a system and method for accepting user-provided numerical data representative of business performance measures (hereinafter BPM's aka KPI's) in a given endeavor, typically presented in the form of data table fields, and transforming the data into composite indices that are presented to the user utilizing a plurality of selectable color-coded charts and spreadsheets.

The invention further provides a system and method for organizing and compiling user-provided data by building composite indices from the user data fields using a plurality of statistical functions. The indices constructed are then used to populate reports that may be color-coded based on predetermined ranking criteria that are tailored to the user's data.

The system and method of the present invention is particularly suited to implementation through programming instructions supplied to a micro-computer, or alternatively one of many conventional microprocessors having associated memory. In an exemplary embodiment of the invention, a Microsoft .Net application is employed to develop suitable software instructions to implement the invention. Furthermore, a wide variety of computer architectures may be employed for implementation of the invention, including client/server configurations, distributed applications, web applications, and portable applications.

### BRIEF DESCRIPTION OF THE DRAWINGS

A better understanding of the present invention will be had upon reference to the following description in conjunction with the accompanying drawing Figures, wherein:

FIG. 1 is a diagram of database architecture in accordance with the present invention:

FIG. 2 is a diagram of a data importation process in accordance with the present invention:

FIG. 3 is a diagram of a data importation process in accordance with the present invention:

FIG. 4 is a flow diagram of the method of the present invention:

FIG. 5 is a depiction of a data transformation process in accordance with the present invention:

FIG. 6 is a system integration diagram in accordance with one embodiment of the present invention:

### DETAILED DESCRIPTION OF THE PREFERRED EMBODIMENTS

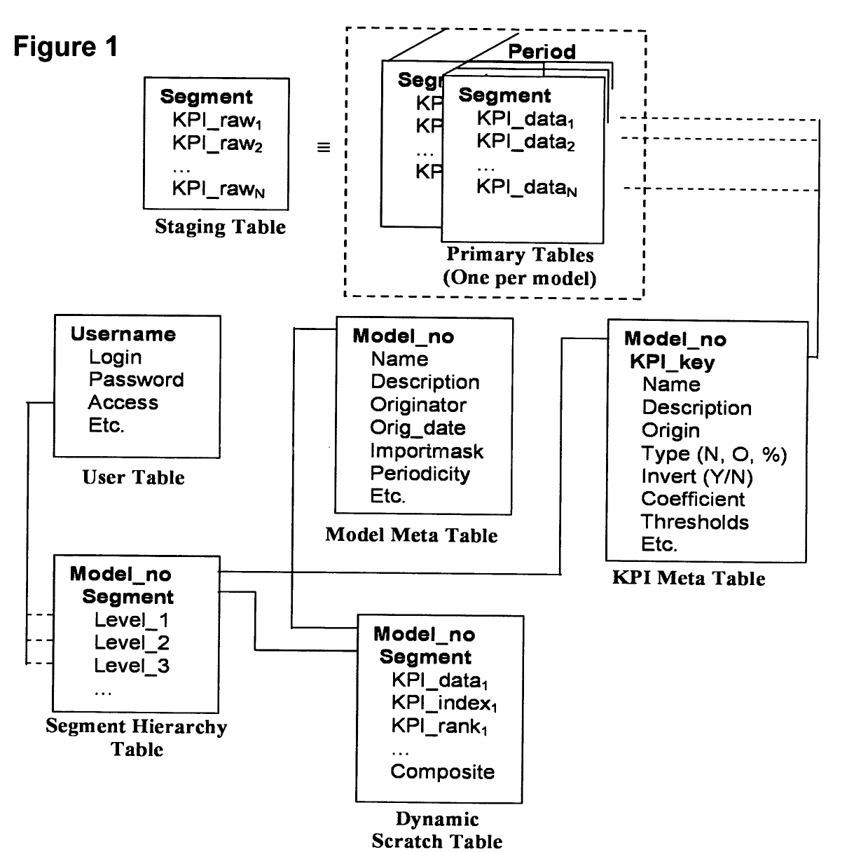

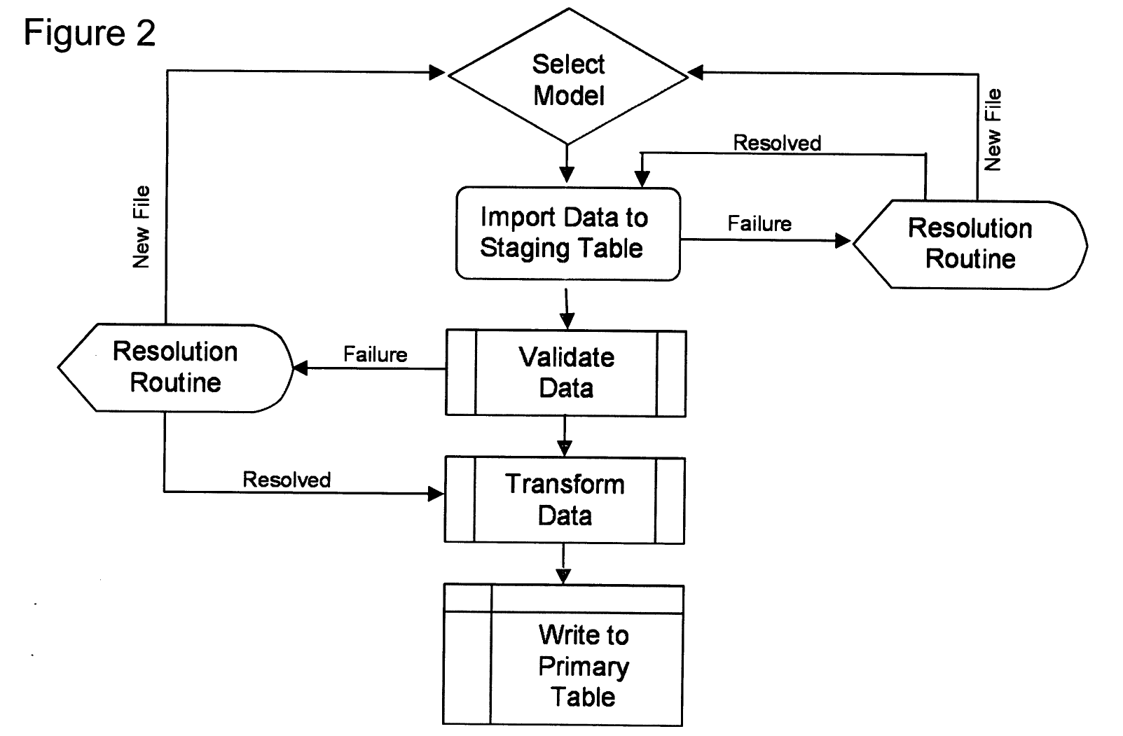

As depicted in the drawing Figures and in accordance with a preferred embodiment of the invention, a system and method for analyzing and displaying BPM data to facilitate analysis of crucial performance measures includes a database as shown in FIG. 1 for storing and manipulating key performance indicator data. In a preferred constructed embodiment of the invention a SQL database engine is employed. As best seen in FIG. 2, the present invention permits manual importation of user performance data to a staging or temporary table prior to validating the BPM data to ensure that the imported data is in the proper range and format to be operated on by the system. Once validated, the data is transformed into a format that allows for additional processing by the system, thence written to a primary table in the database. Logical data resolution routines are provided for data that fails to import to the staging table or is incapable of proper validation prior to the transformation step.

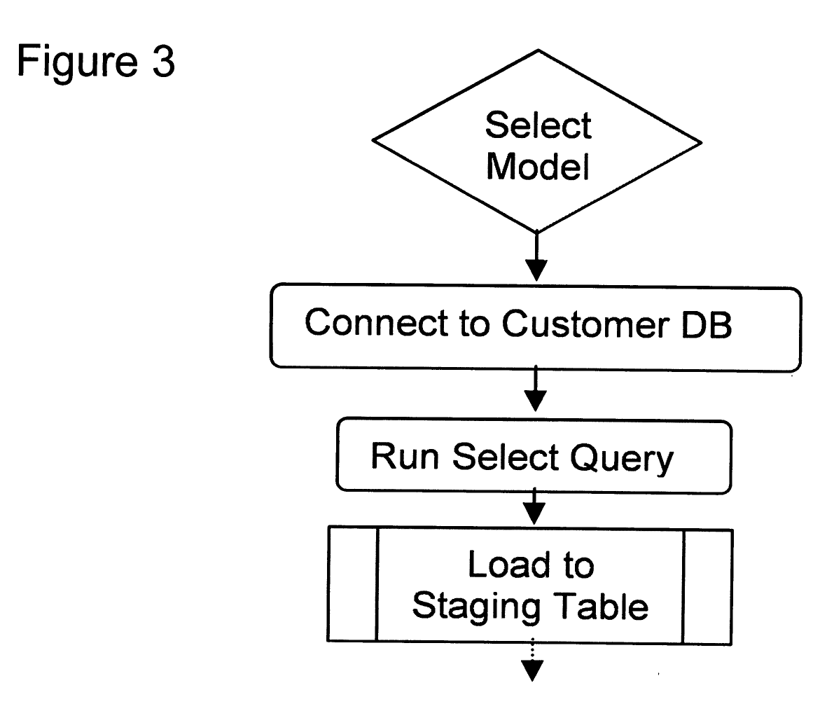

In an alternative embodiment of the invention, as shown in FIG. 3, wherein the user's performance data is structured such that it may be imported directly to a staging table, a select query may be used to extract user data directly from the user's database into the staging table. The logic performed by the system to import the data is accomplished by supplying suitable computer instructions to a microprocessor that communicates with the database.

Data acquisition is initiated through a pull-down menu that permits a user to select one of a plurality of data models for the data importation process. Once a model is selected, the invention informs the user, via a graphical display, pertinent model information, including the most recent data updates. If new updates are required or available the system automatically accesses the data at this time without further action from the user.

Where a user does not wish the system to access to the user's database directly, the system accesses preformatted extract files from the customer that includes the business performance measure data and segment (or category) for the previously selected model. The import file structure may be any one of a plurality of file formats supported by the database engine, including but not limited to xls, .mdb, .txt, and .csv formats. The present invention filters the preformatted data via a mask that reflects the selected model, and then writes the data into the staging table.

Where the user prefers to interconnect their database directly to the system, the invention will query the user's database to retrieve and load the requisite model data. The system's connection to the user's database may be accomplished directly using native software drivers or indirectly by utilizing Open Database Connectivity Standards (OBDC).

Once the BPM data is loaded to the staging table, the system validates the loaded data by comparing it to a set of stored parameters relating to the models, segments and BPM variables, as well as basic mathematical rules pertaining to the BPM data such as value ranges, restrictions; against null values, etc. If the data being validated does not conform to the system data parameters, the system prompts the user with a display of the non-conforming data and available options for correcting it. Once validated, the BPM data is normalized in the transform data step thence stored in the primary data table.

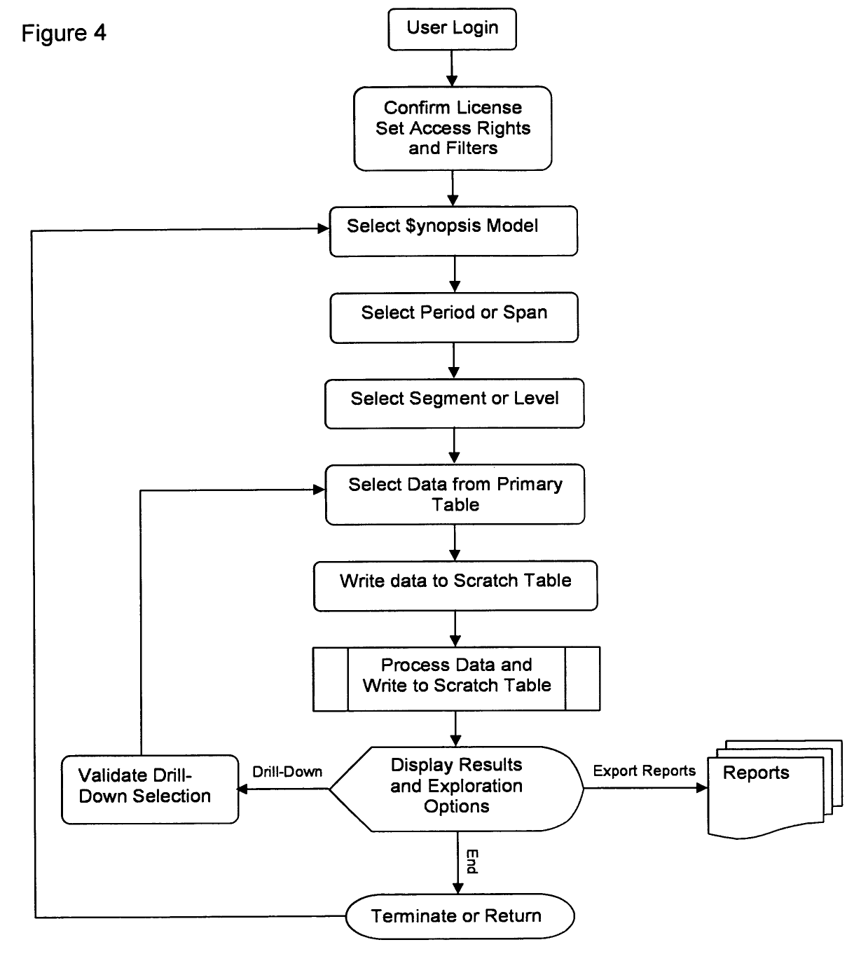

As best seen in FIG. 4, the present invention permits a user to perform a plurality of data transformation functions that enable quick and efficient BPM analysis. At the initiation of the process a user is prompted to login to the system of the present invention using a pre-arranged password. A system server allows varying levels of system access to user predicated on a security clearance level. For example, a lower-level employee of a user entity (a business) may only be granted access to data pertaining directly to that user's responsibilities or applicable performance data. A user that is designated as an administrator has complete access to the entity's data and may also be permitted to add, edit, or delete users. This feature of the present intention permits a plurality of users within an organization to have multiple levels of access to that organization's data, based upon their position within that organization. The level of access of a user is stored in the system server along with the associated passwords.

Once a user has logged in, they may select the desired data model via a pull-down menu display. Once selected, the system then shows the user all model information, including the latest data updates. Where data updates are necessary the system will automatically access the data where a direct database connection is available, or alternatively prompt the user to import data manually, using the procedure discussed herein above.

The user may next select a period or span of periods for the data being transformed in the present invention, and may also select a segment or segments of interest to view via a pull-down menu. Only segments permitted by the user's clearance level will be displayed in the pull-down menus. Furthermore, a user may have a variety of preferred segments that are pre-selected, based on the user's preference. Once the user selects the required segments, period and model, these criteria are used to retrieve the data from the primary table as necessary. The retrieved data is then stored in a scratch table for processing according to the core mathematics and logical model of the invention as set forth in FIG. 4, wherein the present invention calculates a Composite Index for each segment's business performance measure (BPM) data. Once the system calculates all requisite indices, the results thereof are written to the scratch table.

The resultant data is then displayed in a collective view to the user: Synopsis View, a Pareto View, Composite View, or Trends View may then be selected by the user in a full screen format.

Each of the resultant reports may be exported to the user's system in a plurality of formats such as Excel, DBF, PDF, etc. Furthermore, each of the segments in a report may be selected for “drill-down” viewing wherein the invention will verify that a lower level of data detail is available, then display the requested data. The user may also return to any other view, select another report or return to the application's initial screen to select an alternative model or end the session.

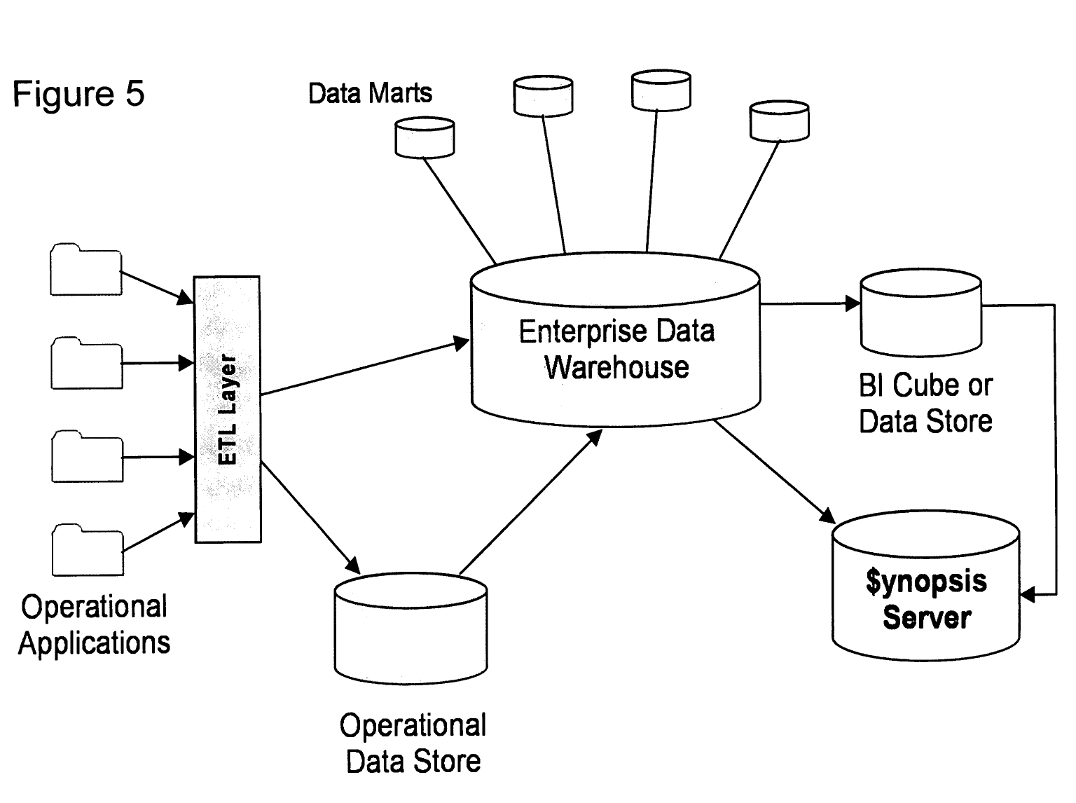

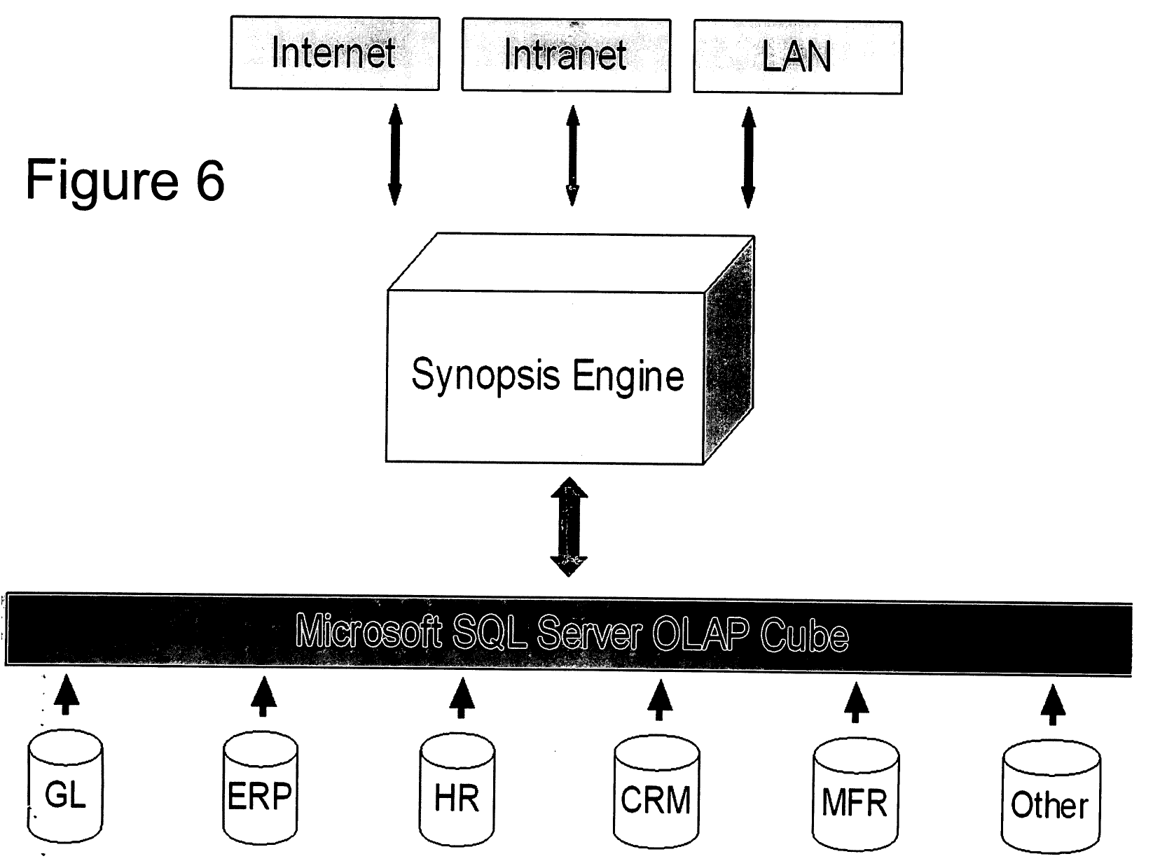

The present invention may be advantageously employed as a server that permits access to registered users as best seen in FIG. 6, or as in FIG. 5, which shows an exemplary user entity information system infrastructure integrated with the present invention. In this example, data collected at an operational level from a plurality of collection systems is extracted, transformed, and loaded (ETL) to an Enterprise Data Warehouse (EDW) that is then used to supply data to the present system and method. The system of the present invention operates as an autonomous client/server application, maintaining a separate database for storage and manipulation of user data. The system will provide users with client software that may be installed in user computers that facilitates system access and use. In an alternative embodiment of the present invention, ASP model client software is available to support user access via inter and intra net browsers.

The foregoing detailed description of the preferred embodiments is considered as illustrative only of the principles of the invention. Since the instant invention is susceptible of numerous changes and modifications by those of ordinary skill in the art, the invention is not limited to the exact construction and operation shown and described, and accordingly, all such suitable changes or modifications in structure or operation which may be resorted to are intended to fall within the scope of the claimed invention.

1. The present invention is a system and method for data visualization that solves the problem of collecting data, analyzing multiple performance measures and disseminating relevant information about complex data. The core mathematics used by the invention are based on Six Sigma statistical measures of variance.

2. The invention allows users to analyze and segment data from a variety of sources in a graphical drill-down decision support environment. Composite indices are derived using an analog of statistical results of multiple BPM's to produce performance segments. All results are displayed in a plurality of selectable color-coded charts and spreadsheets.
